(19) United States
(12) Patent Application Publication
(10) Pub. No.: US 2016/0357844 A1
(43) Pub. Date: Dec. 8, 2016

(54) DATABASE APPARATUS, SEARCH APPARATUS, METHOD OF CONSTRUCTING PARTIAL GRAPH, AND SEARCH METHOD

(71) Applicant: KABUSHIKI KAISHA TOSHIBA, Tokyo (JP)

(72) Inventor: Toshio ITO, Kawasaki (JP)

(21) Appl. No.: 15/066,462

(22) Filed: Mar. 10, 2016

(30) Foreign Application Priority Data
Jun. 3, 2015 (JP) 2015-113166

(51) Int. Cl. G06F 17/30; G06F 11/30

(52) U.S. Cl. CPC G06F 17/30598; G06F 17/30958; G06F 17/30477; G06F 11/3003

(57) ABSTRACT

According to one embodiment, a database apparatus includes an information acquirer, a segment constructor, a period calculator and a storage. The information acquirer acquires, regarding a plurality of processes executed in an information processing system and transitions among the processes, a plurality of pieces of edge information including first information on an attribute of the process before the transition, second information on an attribute of the process after the transition and third information on an attribute of the transition. The segment constructor combines a plurality of data structures comprising a first node indicated by the first information, a second node indicated by the second information and an edge connecting the first and second nodes indicated by the third information, to obtain a plurality of segments for each of a plurality of segment types, by integrating the same nodes in a plurality of pieces of edge information into one node.

### CROSS-REFERENCE TO RELATED APPLICATIONS

This application is based upon and claims the benefit of priority from Japanese Patent Application No. 2015-113166, filed Jun. 3, 2015; the entire contents of which are incorporated herein by reference.

### FIELD

Embodiments described herein relate generally to a database apparatus, a search apparatus, a method of constructing a partial graph and a search method.

### BACKGROUND

A system trace technology is available to keep track of an operating state of a computer system. The system trace technology is a technology that traces a data flow of the system, creates a data flow graph and thereby records/analyzes an operation history of the computer system in detail. In the event of abnormality in the system, the system trace technology analyzes causes of the abnormality and identifies a location of the abnormality based on the data flow graph, and can thereby seek to restore the system as early as possible. Furthermore, by implementing appropriate performance improvement for parts having a problem with performance, the system trace technology can maintain service quality.

When a search is performed at a specified time to detect the position of desired data at the predetermined time, a whole region of a data flow graph recorded by the time at which the search is performed becomes a search range. For this reason, when the system grows in scale, becomes more complicated and there is a large amount of graph data, the quantity of computer resources and calculation time necessary for the detection process also increase, making it difficult to speedily grasp and analyze the state.

### BRIEF DESCRIPTION OF THE DRAWINGS

FIG. 1 is a block diagram illustrating an example of a schematic configuration of a search apparatus according to a first embodiment;

FIG. 2 is a diagram illustrating an example of a data flow graph;

FIG. 3 is a diagram illustrating an example of a data structure of a graph edge;

FIG. 4 is a diagram illustrating an example of node data;

FIG. 5 is a diagram Illustrating an example of edge data;

FIG. 6A and FIG. 6B are a diagram Illustrating examples of a segment type;

FIG. 7 is a diagram illustrating an example of segment data;

FIG. 8 is a diagram illustrating an example of segment type data;

FIG. 9A and FIG. 9B are a diagram illustrating examples of data period calculation;

FIG. 10 is a diagram illustrating an example of a data period;

FIG. 11 is a schematic flowchart of a flow graph updating process;

FIG. 12 is a flowchart of a graph edge adding process;

FIG. 13 is a flowchart of a segment constructing process of a connected component type;

FIG. 14 is a flowchart of a segment constructing process of a path type;

FIG. 15 is a flowchart of a data period updating process;

FIG. 16 is a flowchart of a search process;

FIG. 17 is a diagram illustrating an example of a control flow graph;

FIG. 18 is a diagram illustrating an example of a graph node;

FIG. 19 is a diagram illustrating an example of a data structure of a graph edge according to a second embodiment;

FIG. 20 is a diagram illustrating an example of node data according to the second embodiment;

FIG. 21 is a diagram illustrating an example of edge data according to the second embodiment; and

FIG. 22 is a block diagram illustrating an example of a hardware configuration according to an embodiment of the present invention.

### DETAILED DESCRIPTION

Embodiments will now be explained with reference to the accompanying drawings. The present invention is not limited to the embodiments.

According to one embodiment, a database apparatus includes an information acquirer, a segment constructor, a period calculator and a storage. The information acquirer acquires, regarding a plurality of processes executed in an information processing system and transitions among the processes, a plurality of pieces of edge information each including first information on an attribute of the process before the transition, second information on an attribute of the process after the transition and third information on an attribute of the transition. The segment constructor combines a plurality of data structures each comprising a first node indicated by the first Information, a second node indicated by the second information and an edge connecting the first and second nodes indicated by the third information, to obtain a plurality of segments for each of a plurality of segment types, by integrating the same nodes in a plurality of pieces of edge information into one node. The period calculator calculates data periods indicating respective time ranges of the plurality of segments. The storage stores the plurality of segments.

Below, a description is given of embodiments of the present invention with reference to the drawings.

### First Embodiment

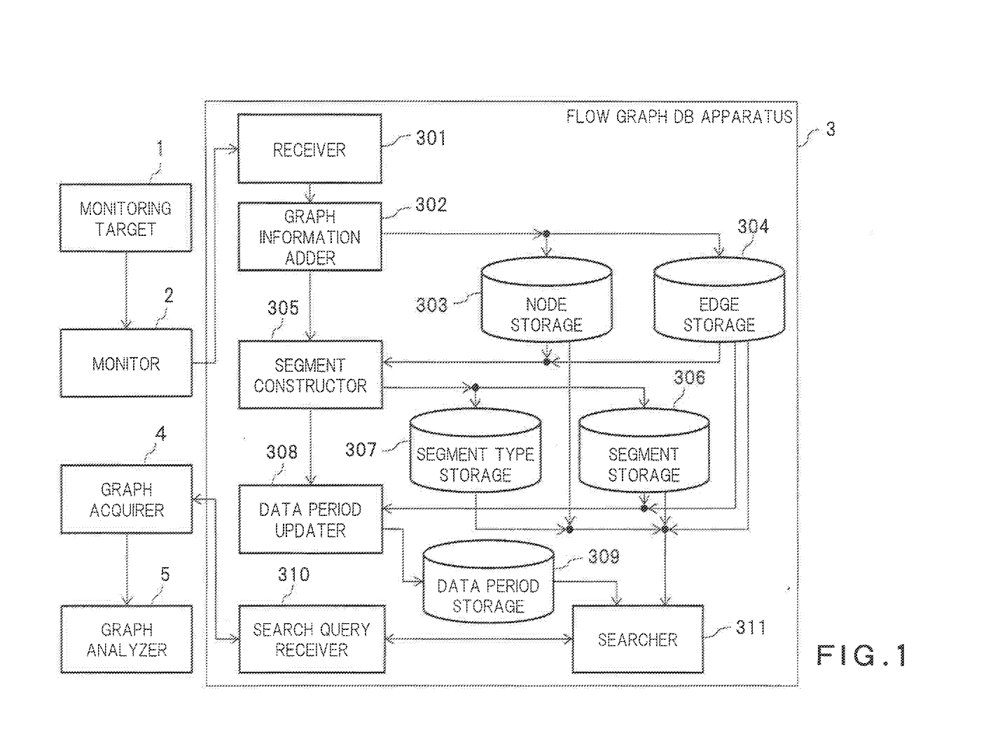

FIG. 1 is a block diagram illustrating an example of a schematic configuration of a search system according to a first embodiment. The search system according to the first embodiment is provided with a monitoring target 1, a monitor 2, a flow graph DB (database) apparatus 3, a graph acquirer 4 and a graph analyzer 5. The flow graph DB apparatus 3 is provided with a receiver 301, a graph information adder 302, a node storage 303, an edge storage 304, a segment constructor 305, a segment storage 306, a segment type storage 307, a data period updater 308, a data period storage 309, a search query receiver 310 and a searcher 311.

The search system according to the first embodiment expresses a processing flow in the monitoring target 1 which is an information processing system using a graph called a “flow graph.” The flow expressed in the flow graph may be anything. For example, it can be a flow relating to processed data (data flow) or a flow relating to a flow of processing itself (control flow). A case with a flow relating to processed data will be described in the first embodiment. Note that the number of information processing apparatuses making up the information processing system may be one or plural.

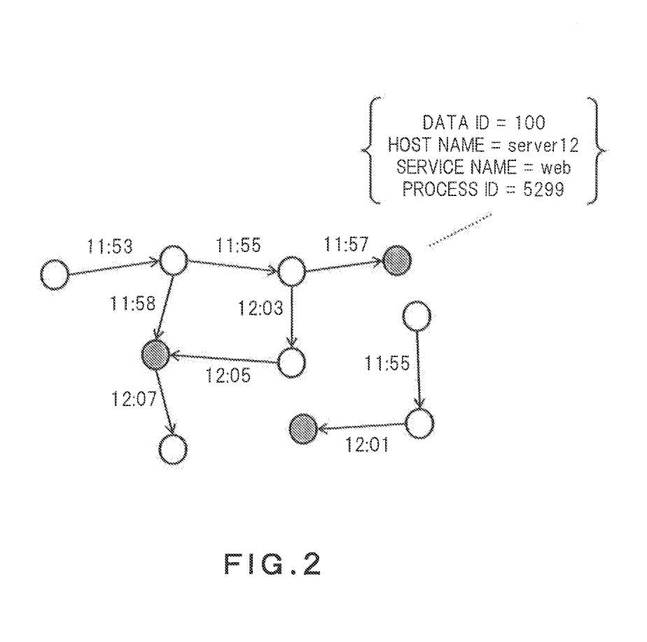

FIG. 2 is a diagram illustrating an example of a data flow graph. The flow graph is made up of nodes represented by circles and edges represented by lines.

A node denotes the position of data in the monitoring target 1 at a certain time. The position of data means one or both of a host and a process that are processing the data at the certain time. The node stores information relating to data. For example, as shown at the top right of FIG. 2, the node stores attribute information such as a data identifier (ID), a host name of a computer in which the data exists, the name of a service that handless the data and a process name (process ID).

An edge connects one node to another node and denotes an event (data flow event) indicating that data flows from the one node to the other node. The edge stores a time at which the data flows as attribute information. This attribute information is called a “time stamp of the edge”. For a given node, an edge that flows into the node is called an “input edge” and an edge that flows out of the node is called an “output edge.”

A flow graph may be generated for each content of data or a process, or a flow graph may contain data flows about a plurality of pieces of data or a plurality of processes in one system. For example, FIG. 2 includes two Independent data flow graphs: a data flow graph starting from an edge at the left top at time 11:53 and a data flow graph starting from an edge at the right middle at time 11:55.

It is possible to acquire various kinds of knowledge relating to operation of the monitoring target 1 by analyzing the data flow graph. For example, if a time at which an abnormality occurs is given and a node at which data is assumed to be processed at the relevant time Is extracted from the data flow graph, it is possible to narrow down the locations causing the abnormality or estimate a range of influences of the abnormality. For example, in FIG. 2, when an abnormality of the monitoring target 1 is detected at 12:06, the black nodes which are nodes at which data is processed at time 12:06 are detected.

Furthermore, in order to analyze abnormality multilaterally, for example, a set of hosts or a set of services that were processing data at the time of the abnormality may be searched for instead of detecting one node.

In order to detect a target node from the data flow graph, it is necessary to collect input edges and output edges from all nodes and investigate their time stamps. However, since the whole data flow graph is generally extremely large-scale data, fully searching nodes is not realistic from the standpoint of a processing time, storage capacity required for search processing or the like. Thus, the search system according to the first embodiment divides the data flow graph into one or more partial graphs and searches the partial graphs. Hereinafter, this partial graph will be referred to as a “segment.”

The monitor 2 monitors processing of the monitoring target 1 and acquires, every time a process such as data transfer or conversion is performed, event information relating to the process. The event information may be directly handed over from the monitoring target 1 to the monitor 2 or may be indirectly acquired by the monitor 2 monitoring data that flows into a network of the monitoring target 1 or monitoring a log file generated by the monitoring target 1.

The monitor 2 generates a graph edge based on the acquired event information. The graph edge refers to a minimum unit of data that forms a data flow. A data structure of the graph edge is made up of three types of attribute: a start point node attribute, an end point node attribute, and an edge attribute. The graph edge is expressed by a structure made up of two nodes and one edge on a flow graph.

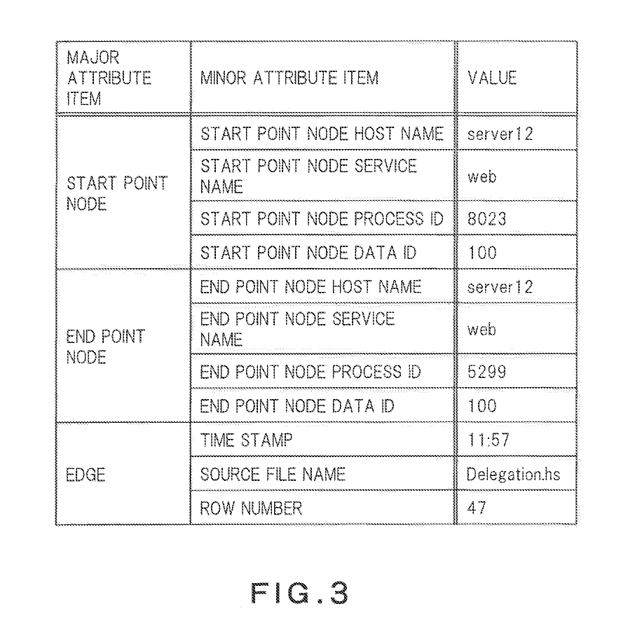

FIG. 3 is a diagram illustrating an example of a data structure of a graph edge. A start point node means a start point of a data flow represented by the graph edge, that is, an source node from which data flows. An end point node means an end point of the data flow, that is, a destination node to which data flows. A start point node attribute and an end point node attribute respectively have attributes such as a host name, a service name, a process ID, and a data ID, and these attributes make it possible to grasp event information relating to this graph edge.

An edge attribute includes attributes such as a time stamp, a source file name, and a row number. The time stamp indicates a time at which a data flow event represented by this graph edge occurs. The source file name is a source file name of a program that causes this data flow. The row number is a row number in the source file.

Note that the attributes relating to the above-described graph edge are examples and the attributes are not limited to the examples in FIG. 3. There may be attributes that are not included or other attributes may be included.

The graph edge generated by the monitor 2 is input to the flow graph DB apparatus 3. Note that the monitor 2 generates the graph edge here, but the flow graph DB apparatus 3 may also generate the graph edge. The monitor 2 may input all the information relating to the detected data to the flow graph DB apparatus 3, and the flow graph DB apparatus 3 may perform filtering or the like and generate edge data.

The flow graph DB apparatus 3 stores data relating to the flow graph of the data processed by the monitoring target 1. Moreover, the flow graph DB apparatus 3 constructs segments which are partial graphs of the flow graph. The flow graph DB apparatus 3 assigns a data period to a constructed segment. The data period means a period during which the data is processed in the part of the data flow represented by the segment.

The graph acquirer 4 acquires a partial graph to be analyzed from the flow graph DB apparatus 3. The graph acquirer 4 generates a search query for the analysis target, sends the search query to the flow graph DB apparatus 3, and the flow graph DB apparatus 3 detects the partial graph based on the search query acquired from the graph acquirer 4 and sends the partial graph to the graph acquirer 4.

The graph analyzer 5 receives and analyzes the partial graph acquired by the graph acquirer 4. This analysis makes it possible to acquire, for example, a list of computer hosts that were processing data at the time of abnormality or a list of data processed at the time of abnormality.

Hereinafter, the flow graph DB apparatus 3 will be described in detail.

The receiver 301 receives the graph edge from the monitor 2. The received graph edge is handed over to the graph information adder 302.

The graph information adder 302 stores the acquired graph edge in the edge storage 304. The graph information adder 302 also stores information on the start point node and the end point node of the graph edge in the node storage 303 when necessary.

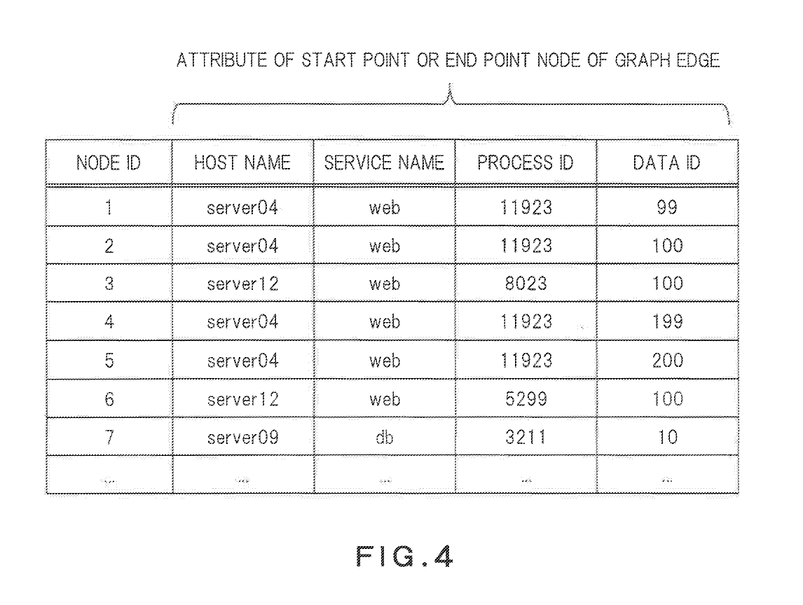

The node storage 303 stores node data which is data relating to nodes of the flow graph. FIG. 4 is a diagram illustrating an example of node data stored in the node storage 303. A node ID denotes an ID that uniquely identifies a node. The node ID may also be assigned by the receiver 301, the graph information adder 302 or the node storage 303. A host name, a service name, a process ID and a data ID are similar to the node attributes of the graph edge shown in FIG. 3. The node ID is unique in the node storage 303. The combination of the node attributes is also unique in the node storage 303. The node ID is associated with combination of the host name, the service name, the process ID and the data ID in the example in FIG. 4, but the node ID may also be associated with combination of other pieces of attribute information.

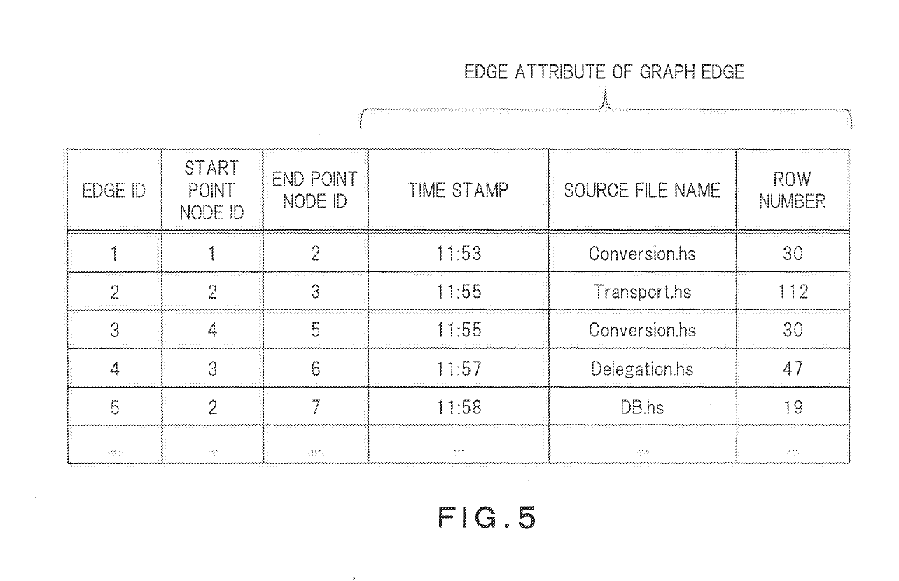

The edge storage 304 stores edge data which is data relating to edge of the flow graph. FIG. 5 is a diagram Illustrating an example of edge data stored in the edge storage 304. An edge ID denotes an ID that uniquely identifies an edge. The edge ID may also be assigned by the receiver 301, the graph information adder 302 or the edge storage 304. A start point node ID and an end point node ID denote a start point node and an end point node connected by the edge respectively, and correspond to the node ID stored in the node storage 303. A time stamp, a source file name and a row number are similar to the edge attributes of the graph edge shown in FIG. 3. The edge ID is associated here with combination of the start point node ID, the end point node ID, the time stamp, the source file name and the row number, but the edge ID may also be associated with combination of other pieces of attribute information.

With reference to the edge data and the node data of the flow graph stored in the edge storage 304 and the node storage 303, the segment constructor 305 newly constructs a segment or divide an existing segment. Hereinafter, construction of a segment may also mean dividing an existing segment. A segment is generated based on a predetermined standard or method and one segment is expressed as a set of one or more nodes.

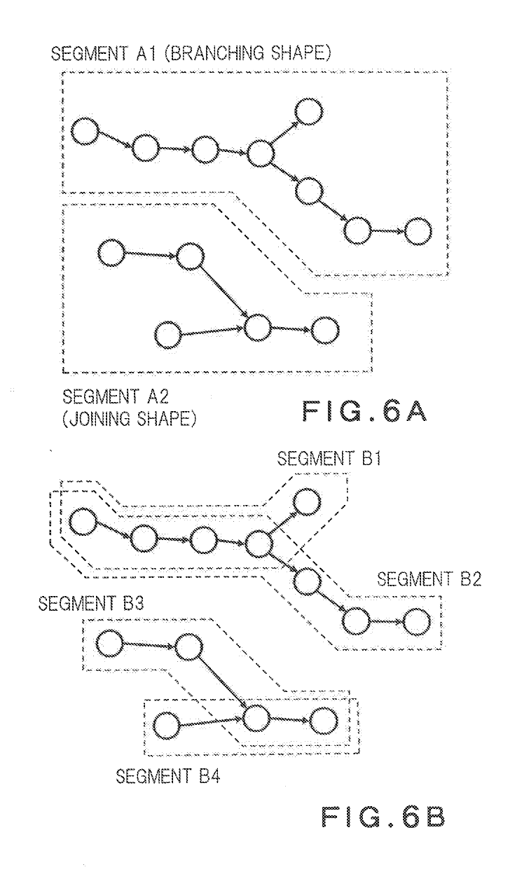

The segment constructed by the segment constructor 305 has a structure which differs depending on the standard or method whereby the segment is constructed. Here, the standard based on which the segment constructor 305 constructs a segment or type of a segment constructed is referred to as a “segment type.” FIG. 6 is a diagram illustrating an example of the segment type. The following segment types can be considered.

A segment constructed of one node is called a “node” type. The node type is a segment with finest granularity.

A segment constructed of a set of accessible nodes by tracing edges in reverse order or forward order is called a “connected component” type, or “component” type for short. All nodes connected to one another when a data graph is illustrated belong to one segment. FIG. 6A is a diagram illustrating an example of the “connected component” type. A segment A1 is a connected component type in which the flow is branched and a segment A2 is a connected component type in which flows are joined.

A segment constructed of nodes having the same “host name” attribute is called a “host” type.

A segment constructed of start point nodes and end point nodes of edges having the same “source file name” attribute is called a “file” type. In this type, one node may be included in a plurality of segments.

A segment constructed of nodes located on one straight path from a node without any input edge to a node without any output edge by tracing output edges in forward order is called a “path” type. In this type, one node may be included in a plurality of segments. FIG. 6B is a diagram illustrating an example of the “path” type. Since the segment A1 shown in FIG. 6A is branched into two flows at a node halfway, when classified by path type, two segments, segment B1 and segment B2, are generated. Moreover, since the segment A2 shown in FIG. 6A is also made up of two flows before the joining, when classified by path type, two segments, segment B3 and segment B4, are generated. Note that since the “path” type segment must necessarily include a start point node and an end point node of the path, the segment constructor 305 assumes that the flow graph contains no cyclic structure.

The segment construction method by the segment constructor 305 varies from one target segment type to another. Hereinafter, operation of the segment constructor 305 when one new graph edge is added will be shown for each segment type.

In the case where a segment is of the “node” type, for a start point node and an end point node of an added graph edge, their respective node IDs are added when there are no such IDs in the segment storage 306 yet, and the segment is registered with the segment type storage 307 as a node type segment.

In the case where a segment is of the “connected component” type, a new segment is registered when neither start point node nor end point node exists in a flow graph. When either the start point node or the end point node exists in the flow graph, a new node is registered with the segment to which the existing node belongs. In the case where both a start point node and an end point node are existing nodes in the flow graph and both nodes belong to different connected components, the two connected components are connected into one large connected component. This segment binding method may be optionally determined. The segment to which the start point node belongs may be bound with the segment to which the end point node belongs or the bound side and the binding side may be determined based on a comparison in segment IDs or the numbers of nodes included in the segments.

In the case where a segment is of the “host” type, for a start point node and an end point node of an added graph edge respectively, nodes having the same host name attribute as that of the node are searched from the node storage 303. When the nodes are detected, the start point node or the end point node are added to the segment to which the detected node belongs. When the nodes are not detected, a segment made up of the start point node or end point node is generated and registered.

In the case where a segment is of a “file” type, edges having the same source file name attribute as that of the added graph edge are searched from the edge storage 304. When the edges are detected, the start point node and the end point node of the graph edge are added to the segment to which the start point node or the end point node connected to the detected graph edge belongs. When the edges are not detected, a new segment made up of the start point node and the end point node of the graph edge is generated.

In the case where a segment is of a “path” type, the segments to be affected by adding a graph edge are reconstructed. The reconstruction is done, for example, by deleting all affected paths once and replacing the paths with newly constructed paths. When influences on the existing path segments are small, it is possible to perform a process of adding a graph edge first and dividing, the segments to which the edge is added into a plurality of path segments, if the segments have branches. Even if a new graph edge is added to any node of the segment through the process of reconstruction, an adjustment is made so as to maintain consistency as the path segment.

Note that the above-described segment construction methods are examples and the method may be optional. For example, instead of updating the segments for every addition, all segments may be reconstructed at a fixed time.

The segment constructor 305 may construct segments of one or a plurality of predetermined segment types from one flow graph, or may construct segments of all segment types it can generate. For example, in the example of FIG. 6, a total of six segments of “connected component” type segments A1 and A2 and “path” type segments B1 to B4 may be created from one data graph.

Furthermore, the segment constructor 305 may construct segments of different segment types from an existing segment. For example, in the case where the “connected component” type segments A1 and A2 in FIG. 6A are already created, it is possible to receive an instruction from an input circuit which is not shown via the receiver 301 or the like and construct the segments B1 to B4 shown in FIG. 6B from the segments A1 and A2.

Furthermore, the segment constructor 305 may determine segment types to be constructed. For example, based on attributes of data newly added to the edge storage 304 and the node storage 303 and predetermined criteria, if the process is determined to be completed by one host, “host” type segments are generated. If the data is determined to be data associated with a plurality of processes by a plurality of hosts, “connected component” type segments may be generated.

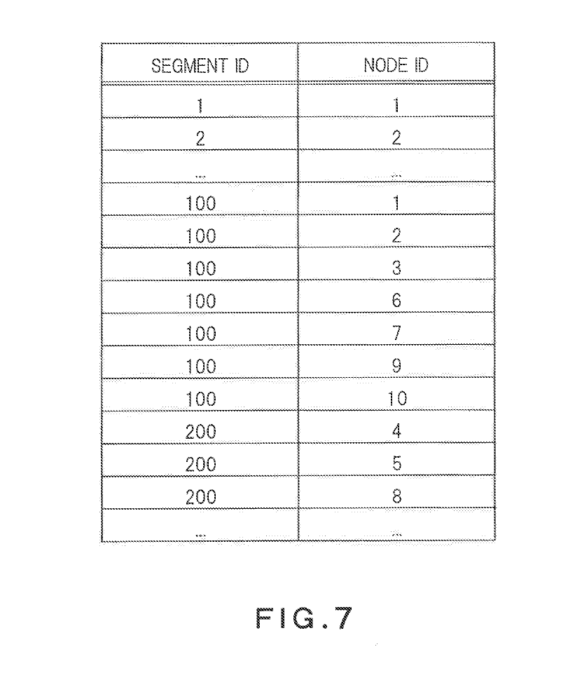

The segment storage 306 stores segment data which is information relating to each piece of segment. FIG. 7 is a diagram Illustrating an example of segment data stored in the segment storage 306. In the example of FIG. 7, a segment ID for uniquely identifying each segment is assigned and a node ID held by each segment is stored. Segment IDs may be assigned by the segment constructor 305 or segment storage 306. Since a plurality of nodes are included in one segment, in the example of FIG. 7, there are the same number of rows with identical segment IDs as the number of nodes included in the segment with the segment ID.

Note that FIG. 7 is an example and other information may also be included. For example, not only node IDs but also edge IDs may be included. Furthermore, information corresponding to node IDs, for example, information stored in the node storage 303 may be included. The data structure may also be different. For example, nodes that belong to a segment may be stored in different columns. In the example of FIG. 7, all segments are stored in one table, but a plurality of tables may be held, each of which stores segments of the same segment type. The structure of each table may differ from one segment type to another.

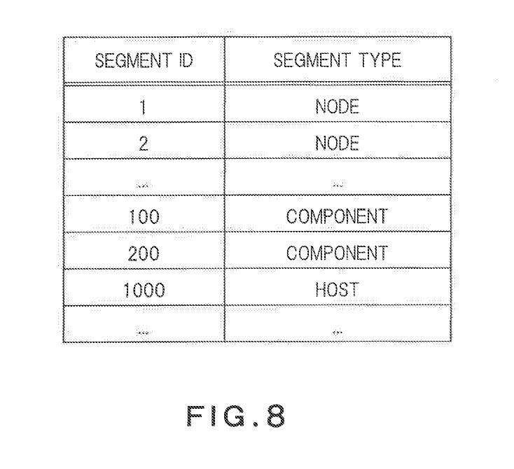

The segment type storage 307 stores attribute Information including segment type information. FIG. 8 is a diagram illustrating an example of segment type data in the segment type storage 307. As shown in FIG. 8, one segment type is associated with one segment ID.

The data period updater 308 calculates a data period in each segment constructed by the segment constructor 305. The data period is calculated from time-related information (time stamp) stored in the plurality of edges included in the segment. Note that the present embodiment assumes that the data period is calculated from edges since the edge attribute includes a time stamp, but when a node includes a time stamp, the data period may be calculated from nodes. Furthermore, when both the node and the edge include time stamps, the data period may be calculated from any one or both of the node and the edge.

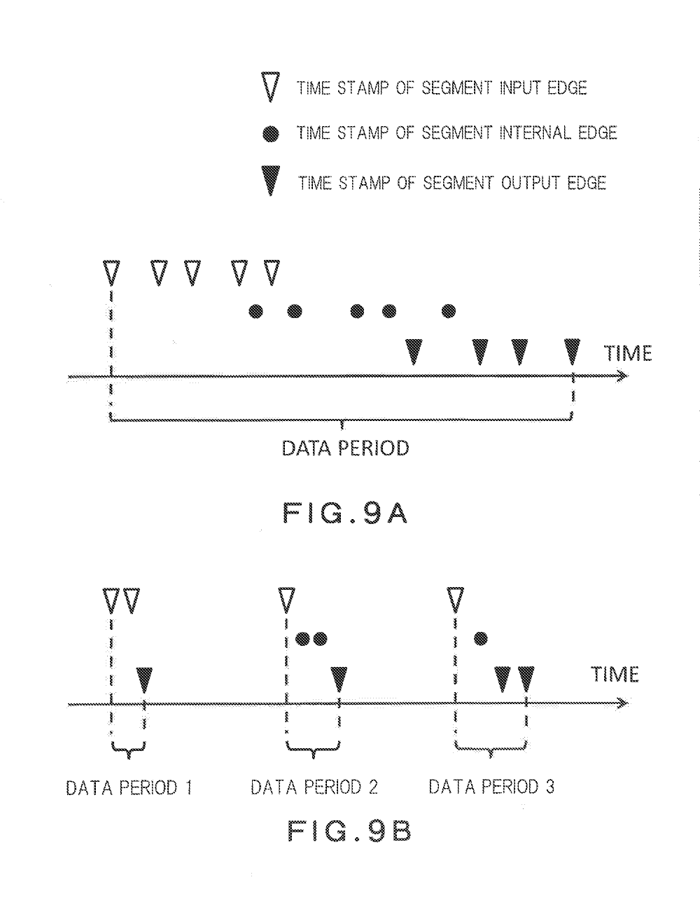

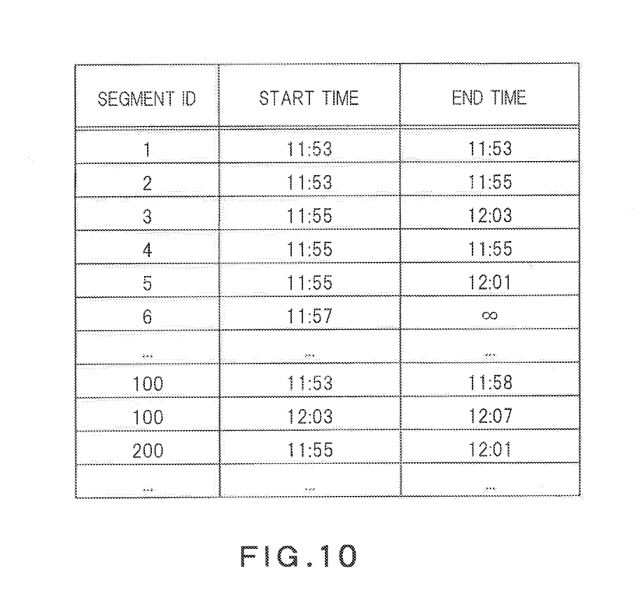

FIG. 9 is a diagram illustrating an example of data period calculation. In this example, the data period updater 308 uses time stamps of three groups: time stamps of segment input edges, time stamp of segment output edges and time stamps of segment Internal edges. The segment input edge means an edge whose start point node is a node outside the segment and whose end point node is a node inside the segment. The segment output edge means an edge whose start point node is a node inside the segment and whose end point node is a node outside the segment. The segment internal edge means an edge whose start point node and end point node both belong to the segment. A “node” type segment or the like may have a plurality of segment input edges and segment output edges. A set of these edges may be extracted from the edge storage 304 or the segment storage 306 or the like based on segment information of the segment storage 306.

The method of data period calculation may be optional. For example, as shown in FIG. 9A, the earliest time of time stamps of segment input edges may be designated as the data period start time and the latest time of time stamps of segment output edges may be designated as the data period end time. Alternatively, with attention focused on only a specific group, for example, the earliest time of time stamps of the segment internal edges may be designated as the data period start time and the latest time may be designated as the data period end time. Alternatively, irrespective of the types of the three types of time stamps, the time period between the earliest time and the latest time of the time stamps of all the edges included in the segment may be designated as the data period. Furthermore, the data period start time may not be the earliest time of the group. The data period start time may be an average value of time stamps of the group or may be determined optionally such as the third-earliest time. Similarly, the data period end time may not be the latest time of the group.

The data period updater 308 may calculate a plurality of data periods for one segment. That is, one segment may include a plurality of data periods. FIG. 9B is a diagram illustrating an example in which a plurality of data periods are calculated. In this example, time stamps accompanying the segment are divided into three groups with respect to the time axis. The data period updater 308 calculates a data period for each of these groups.

For example, consider a “connected component” type segment in the case where for certain data of the monitoring target 1, a data overwrite and storage process is performed at 10:00, a read process is performed at 10:05, a data overwrite and storage process is performed at 11:00 again and a re-read process is performed at 11:05. In this case, since the data locations are the same, the data storage process performed at 10:00 and 11:00 may share the same node. For this reason, these processes are expressed by one segment. However, if the data period of the segment is assumed to be from 10:00 to 11:05, the segment is extracted also by a search process corresponding to a time zone during which data is not actually processed, for example, from 10:30 to 10:35, which is inefficient. Thus, suppose the segment includes two data periods of the data period 1 from 10:00 to 10:05 and the data period 2 from 11:00 to 11:05. In this case, the segment is not extracted in the search process corresponding to 10:30 to 10:35, and the search efficiency improves.

To calculate a plurality of data periods, the groups of data as shown in FIG. 9B are classified into a plurality of groups (clustering). Clustering can be done by causing a computer or the like to execute mechanical processing based on a general clustering algorithm such as the shortest distance method and the K-means method.

The data period updater 308 may change the method of calculating a data period, segment by segment based on segment information such as the number of nodes and the number of edges or segment type or the like. For example, since a “node” type segment has no segment internal edge, a data period is calculated based on the segment input edges and the segment output edges. On the other hand, conversely, a “connected component” type segment has only segment internal edges, and so a data period is calculated based on only time stamps of the Internal edges.

Depending on segments, there may be cases where a finite data period cannot be calculated. For example, in the case of a “node” type segment that has only one edge, only one time stamp can be used to calculate its data period. In such a case, the data period may be assumed to be “none.” Alternatively, both the data period start time and the data period end time may be set to the time stamp, that is, the same time. Alternatively, the data period start time may be set to the time stamp and the data period end time may be set to “∞.” Conversely, the data period end time may be set to the time stamp and the data period start time may be set to “−∞.” In addition, in the case where the data period start time is later than the data period end time as a result of a data period calculation, the data period may be assumed to be “none.”

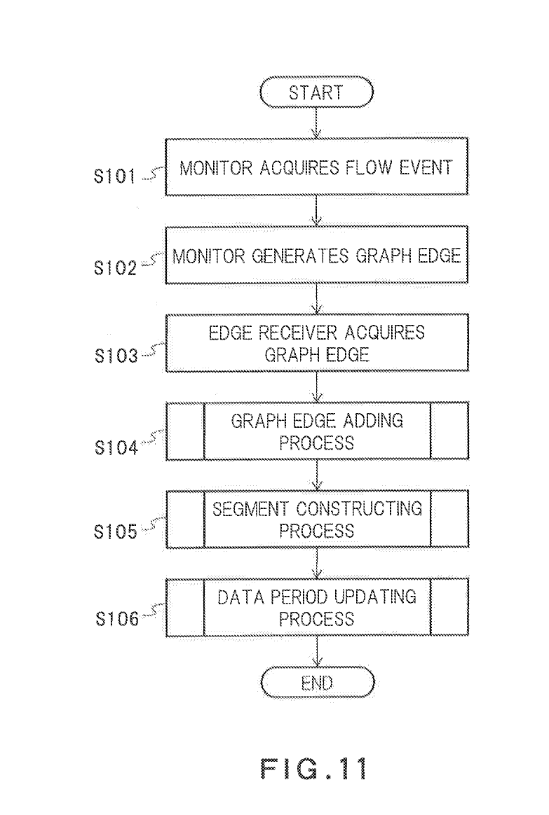

The data period storage 309 stores information on the data period accompanying the segment calculated by the data period updater 308. FIG. 10 is a diagram illustrating examples of data periods stored by the data period storage 309. Segment IDs are associated with start times and end times calculated by the data period updater 308. In the examples in FIG. 10, only start times and end times are stored, but other attributes may also be added. Moreover, a plurality of data periods may also be associated with one segment ID. Although all segments are included in one table, the table may be divided by segment type. When a segment type and a data period are specified in a search process, search efficiency can be increased by searching the table storing only the segment type.

The search query receiver 310 receives a search query issued by the graph acquirer 4. The search query can specify a data period of a segment to be detected and can reduce the number of target segments. Furthermore, a segment type of the search target may be specified or a plurality of conditions may be combined by logical AND, logical OR or the like.

Furthermore, the search query receiver 310 receives the data detected by the search query from the searcher 311 and sends the data to the graph acquirer 4.

Based on the search query acquired from the search query receiver 310, the searcher 311 searches the segment storage 306, the segment type storage 307 and the data period storage 309 and detects desired segments.

More specific processing of the searcher 311 will be described. When the segment storage 306, the segment type storage 307 and the data period storage 309 are implemented as tables of databases that can receive SQL queries, the searcher 311 converts the received search query to an SQL query. An example of the SQL query is as follows.

SELECT s. segment ID, s. node ID

FROM segment storage 306 AS s,
segment type storage 307 AS t,
data period storage 309 AS d

WHERE s. segment ID=t. segment ID
AND s. segment ID=d. segment ID
AND (search condition)

A search condition received by the search query receiver 310 and converted by predetermined conversion rules is input as the “(search condition)” of the above-described SQL query. “AS” in the above-described SQL statement means naming the phrase before “AS” with characters after “as.” In the above-described case, it is assumed that the segment storage 306 is represented by “s,” the segment type storage 307 is represented by “t,” and the data period storage 309 is represented by “d.” Therefore, the first row means that a segment ID and a node ID in the segment storage 306 which is “s” are extracted. The term “where” indicates that the phrase after “where” is an extraction condition. This extraction condition means that a segment ID in the segment storage 306 which is “s” matches the segment ID of the data period storage 309 which is “t” and also matches the segment ID of the data period storage 309 which is “d” and also satisfies the (search condition).

The search condition may be a segment type to be searched, a period during which search is conducted or the like. As the search period, only a start time or an end time may be specified. Note that the start time and the end time of the data period stored in the data period storage 309 may be “−∞” or “∞” respectively, but these may or may not be included in the search period. For example, when the input query specifies a segment type, “(search condition)” becomes as follows.

t. segment type=type

On the other hand, when the input query specifies a data period, “(search condition)” becomes as follows. (d. start time IS NULL AND d. end time IS NULL) OR (d. start time IS NULL AND time<d. end time) OR (d. end time IS NULL AND time>=d. start time) OR (time>=d. start time AND time<d. end time)

“NULL” in the above-described SQL statement means that the start time or end time is “−∞” or “∞.”

Note that the above-described case is an example and the respective storages to be searched need only to be able to receive instructions from the searcher 311 and return results. In the case of the SQL query in the above-described example, although the searcher 311 acquires only the segment ID and the node ID, the searcher 311 may further acquire attributes or edge accompanying each node, or edge from the node storage 303 or the edge storage 304 as search targets. In addition, the segment type of each segment, the number of nodes belonging to the segment or the like may also be acquired.

The searcher 311 converts an input query to a receivable query based on the above-described conversion rules and issues a query to the segment storage 306, the segment type storage 307 and the data period storage 309.

The segment storage 306, the segment type storage 307 and the data period storage 309 return search results based on the data period which is a search condition or other search conditions such as a segment type, and the searcher 311 obtains a list of node IDs of a desired segment. The searcher 311 sends various types of data relating to the acquired segment to the search query receiver 310.

Next, a processing flow of the search apparatus according to the first embodiment will be described. The first embodiment performs a flow graph updating process of updating a flow graph based on monitoring information from the monitor 2 and a search process of returning a search result based on a search query from the graph acquirer 4.

FIG. 11 is a schematic flowchart of the flow graph updating process. The flow starts at timing at which attribute information is sent from the monitoring target 1 or timing at which the monitor 2 detects an event or the like to be monitored.

The monitor 2 acquires a data flow event of the monitoring target 1 from the monitoring target 1 (S101). The monitor 2 generates a graph edge from the acquired data flow event (S102). The monitor 2 sends the generated graph edge to the flow graph DB apparatus 3 and the edge receiver 301 receives the graph edge (S103).

The edge receiver 301 sends the received graph edge to the graph information adder 302, and the graph information adder 302 performs a graph edge adding process (S104). After the graph edge addition process ends, the segment constructor 305 performs a segment constructing process (S105). After the segment constructing process ends, the data period updater 308 performs a data period updating process (S106). This constitutes a schematic flowchart of the flow graph updating process.

After the preceding process ends, each of the above-described processes assumes to receive information on the completion of the process or input data of the next process and start the process, but may also operate at any given timing. The next process may start after the preceding process is executed a plurality of times or when input data exceeds a predetermined reference number. For example, the segment constructor 305 may buffer added graph edges and collectively process graph edges when the number of the graph edges exceeds a predetermined reference number.

Alternatively, the process may operate completely asynchronously to the preceding process. For example, the process may be performed periodically at predetermined times or the like or the process may be performed at a time at which an Instruction is received from an input circuit which is not shown via the receiver 301 or the like. Operation timing may be changed depending on types such as a segment type.

Furthermore, process timing or a method thereof may be changed for each segment type. For example, in a segment constructing process, a segment may be constructed every time a graph edge is added for a “node” type, a “host” type, a “file2 type or the like for which segment construction is relatively easy, when 100 graph edges are added for a “connected component” type or at a fixed time for a “path” type for which segment reconstruction is necessary.

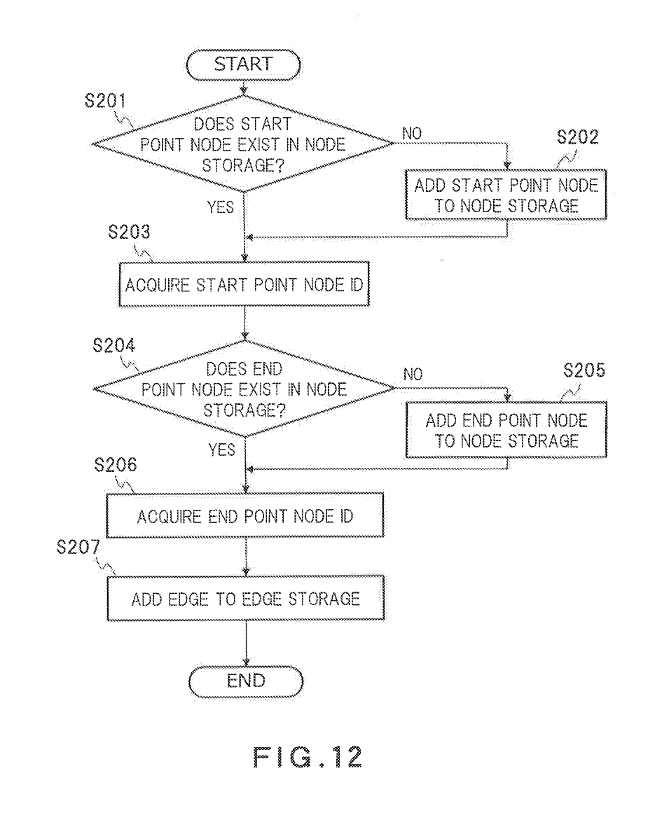

FIG. 12 is a diagram illustrating a flowchart of a graph edge addition process by the graph information adder 302. This shows operation of the graph information adder 302 when adding one graph edge. The graph information adder 302 checks whether or not the start point node of the added graph edge already exists in the node storage 303 (S201). When there is no entry where the entire four node attributes (host name, service name, process ID and data ID) in the graph edge match in the node storage 303 (NO in S201), the node information on the graph edge is stored in the node storage 303 as a new entry (S202). After the node information is stored in the node storage 303 as a new entry or when the start point node exists in the node storage 303 (YES in S201), the graph information adder 302 acquires the node ID of the start point node from the node storage 303 (S203).

Next, it is checked whether or not the end point node of the graph edge already exists in the node storage 303 (S204). When the end point node of the graph edge does not exist in the node storage 303 (NO in S204), node information of the graph edge is stored in the node storage 303 as a new entry (S205). After the node information is stored in the node storage 303 as a new entry or when the end point node exists in the node storage 303 (YES in S204), the graph information adder 302 acquires the node ID of the end point node from the node storage 303 (S206).

The graph information adder 302 stores an edge attribute included in the graph edge as a new entry of the edge storage 304 (S207). This is the flow of the graph edge adding process.

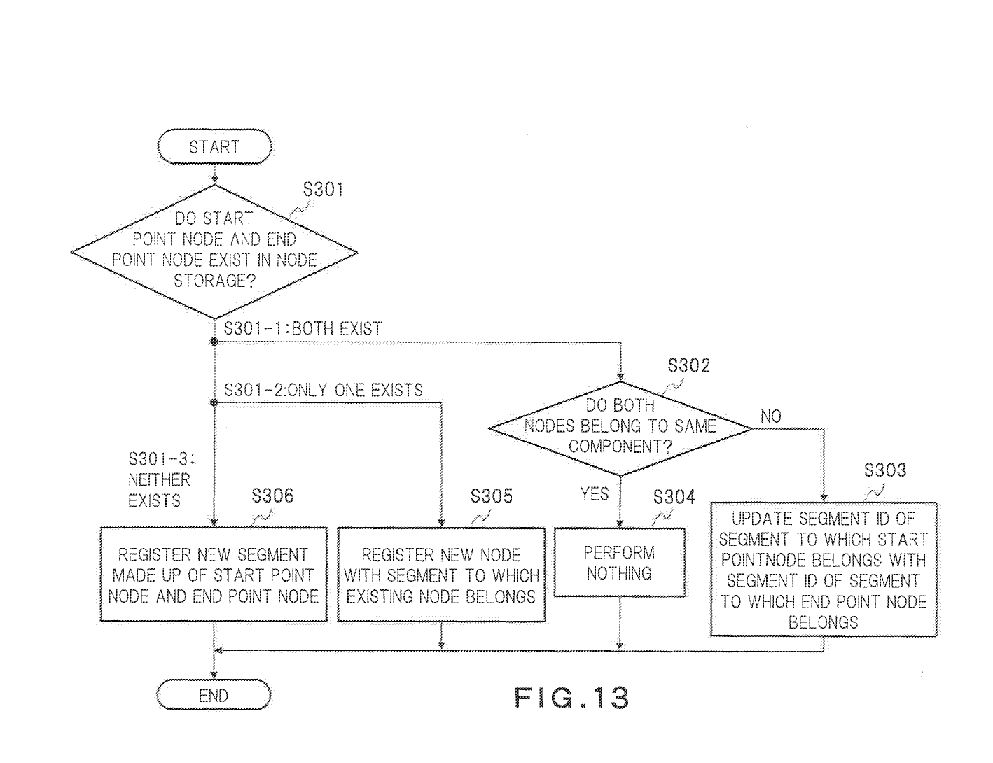

FIG. 13 is a flowchart of a “connected component” type segment constructing process by the segment constructor 305. In this flowchart, a “connected component” type segment is constructed. With the “connected component” type, the segment construction method varies depending on whether the start point node and the end point node of the added graph edge are new nodes or existing nodes, or if both of the nodes are existing nodes, depending on whether both nodes belong to the same segment or not.

The segment constructor 305 checks whether the start point node and the end point node of the added graph edge already exist in the node storage 303 (S301).

When both the start point node and the end point node exist in the node storage 303 (S301-1), the segment constructor 305 checks whether or not the start point node and the end point node belong to the same connected component (S302). When the nodes do not belong to the same connected component (NO in S302), the segment constructor 305 updates the segment ID of the segment to which the start point node belongs with the segment ID of the segment to which the end point node belongs in the segment storage 306 (S303), and ends the process. In this case, two connected components are connected by the added graph edge to form one large connected component. When both nodes belong to the same connected component (YES in S302), the segment constructor 305 performs nothing and ends the process (S304).

When any one of the start point node and the end point node exists in the node storage 303 (S301-2), the segment constructor 305 registers a new node with the segment storage 306 using the segment ID of the segment to which the existing node belongs (S305) and ends the process.

When neither the start point node nor the end point node exists in the node storage 303 (S301-3), the segment constructor 305 registers a new segment made up of the start point node and the end point node with the segment storage 306 (S306) and ends the process. This is the flow of constructing a “connected component” type segment.

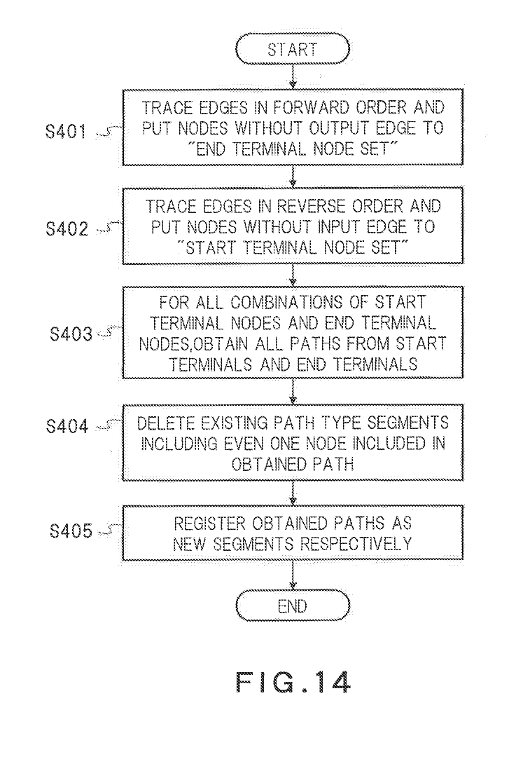

FIG. 14 is a flowchart of a “path” type segment constructing process. According to this flowchart, a “path” type segment is constructed.

With reference to the edge storage 304, the segment constructor 305 traces edges in forward order from the start point node of the newly added edge and puts, in an “end terminal node set,” nodes without any output edge which the segment constructor 305 visits (S401). Furthermore, the segment constructor 305 traces edges in reverse order from the end point node of the added edge and puts, in a “start terminal node set,” nodes without any input edge which the segment constructor 305 visits (S402). For all combinations of start nodes included in the “start terminal node set” and end nodes included in the “end terminal node set,” the segment constructor 305 calculates all paths from start terminal nodes to end terminal nodes (S403). As a method of determining paths, publicly known search algorithms may be used.

The segment constructor 305 deletes the existing “path” type segments that include at least one node in all the calculated paths (S404). The segment constructor 305 then registers the respective calculated paths as new segments (S405). This is the flow of constructing a “path” type segment.

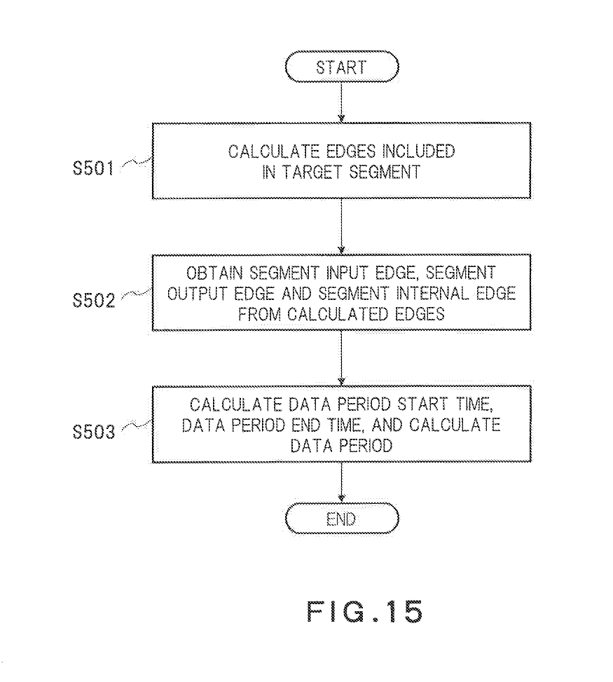

FIG. 15 is a diagram illustrating a flowchart of a data period updating process by the data period updater 308. The flow is a flowchart of processing on one segment. In order to perform a data period updating process on all segments updated by the segment constructor 305, the data period updater 308 repeatedly applies the flow to all target segments.

The data period updater 308 calculates edges included in segments updated by the segment constructor 305 (S501). More specifically, the data period updater 308 extracts nodes included in the updated segments from the segment storage 306 and acquires edges connected to the nodes from the edge storage 304. Information such as segment IDs of updated segments may be acquired from the segment constructor 305 or segment storage 306 to identify the updated segments. Alternatively, flags for identifying target segments whose data period is to be updated may be stored as one field of the table stored in the segment storage 306 so as to be referenced by the data period updater 308.

Note that when the segment constructor 305 calculates edges included in a segment and stores the edges in the segment storage 306 or the like, the stored information may be referenced by the data period updater 308.

The data period updater 308 acquires segment input edges, segment output edges and segment internal edges from the calculated edges based on the information of the edge storage 304 (S502).

The data period updater 308 calculates the data period start time and the data period end time based on the predetermined condition and calculates the data period (S503). As described above, the condition may be such that the earliest time of the time stamps of the segment input edges is assumed to be the data period start time and the latest time of the time stamps of the segment output edges is assumed to be the data period end time. This is the flow of the data period updating process.

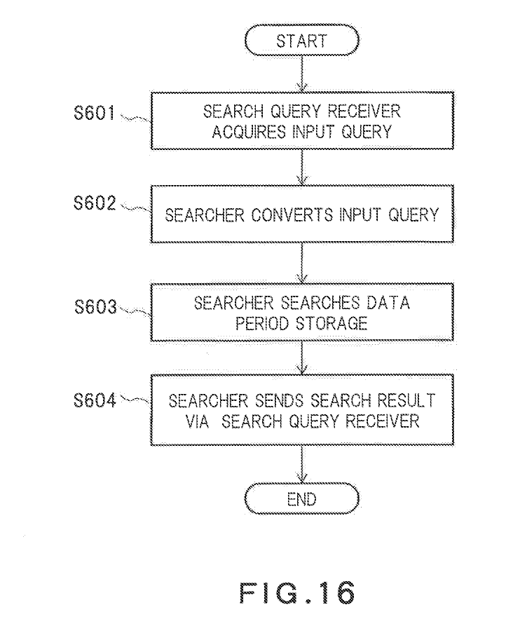

FIG. 16 is a flowchart of a search process. The search query receiver 310 acquires an input query from the graph acquirer 4 (S601). The searcher 311 acquires the input query from the search query receiver 310 and converts the input query to a query that can be received by the segment storage 306, the segment type storage 307 and the data period storage 309 (S602). The searcher 311 issues search queries to the segment storage 306, the segment type storage 307 and the data period storage 309, and acquires search results such as a list of nodes that match the search queries (S603). The searcher 311 sends the search results to the search query receiver 310 (S604) and the graph acquirer 4 acquires the search results via the search query receiver 310. This is the flow of the search process.

As described above, according to the first embodiment, it is possible to search data periods of a segment by constructing a segment based on the information on nodes and edges, and calculating the data periods based on the time stamps of the edges. This makes it possible to efficiently search a node and a set of nodes being subjected to data processing at a specific time and within a specific time range. By constructing various types of segments, it is also possible to flexibly search segments of various units (granularity). Moreover, by specifying segment types, it is possible to perform searches in various units such as a host and a servicer. Furthermore, it is possible to perform searches not in a graph structure of one straight path but also a data flow graph which is a structure including branching and joining.

### Second Embodiment

Next, a second embodiment will be described. Description overlapping with that of the first embodiment is omitted.

In the first embodiment, edge data has time stamps and a data period of a segment is calculated based on the time stamps. On the other hand, the present invention is applicable not only to edges but also to flow graphs in which nodes have time stamps. Thus, in the present embodiment, processing on a control flow graph will be described as an example of the flow graph in which nodes have time stamps.

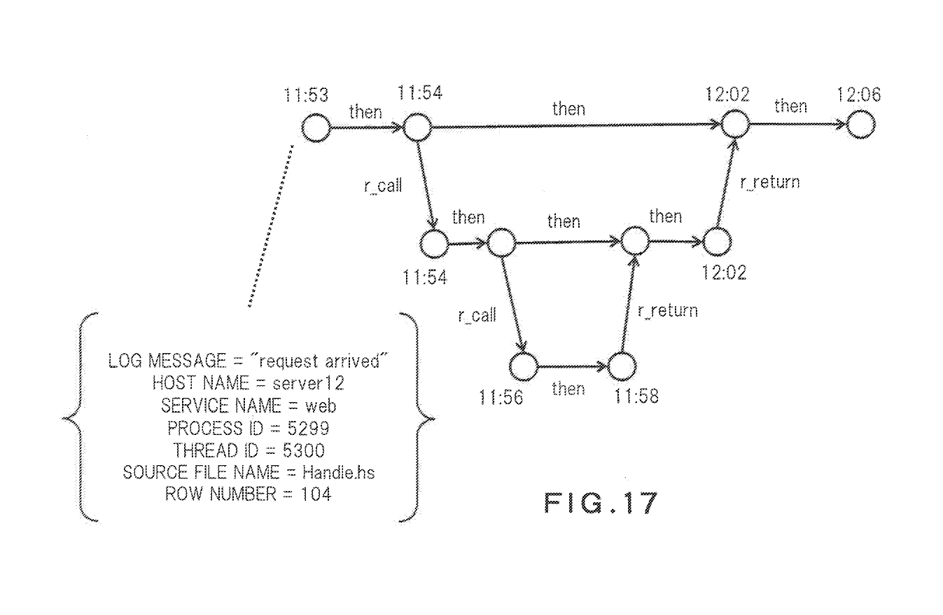

FIG. 17 is a diagram Illustrating an example of a control flow graph. The data flow graph described in the first embodiment illustrates a flow of data processed in the monitoring target 1. On the other hand, the control flow graph illustrates a flow of processing executed in the monitoring target 1 (control flow). A node in the control flow graph represents an event of a certain process and an edge represents a relationship between events.

In the example of FIG. 17, three types of edges: “then,” “r_call,” and “r_return” are recorded. The “then” edge shows that events corresponding to their respective nodes have sequentially occurred in one thread. A process or thread represents a unit of processing executed by a CPU of a computer. One process includes one or a plurality of threads. That is, nodes connected by a “then” edge indicate that the nodes are executed by the same thread. The “r_call” edge indicates that a start point node connected to the “r_call” edge is a request issuance event of RPC (Remote Procedure Call) and that an end point node connected to the “r_call” edge is a request reception event of RPC. The “r_return” edge indicates that a start point node connected to the “r_return” edge is a response issuance event of RPC and that an end point node is a response reception event thereof.

Each node stores attribute information associated with an event indicated by each node. For example, there are attributes such as a time stamp indicating a time at which an event occurs, a log message indicating contents of an event, a host name of a host in which an event occurs, a service name, a process ID, a thread ID, a file name of source code and a row number in the file.

Thus, respective nodes representing events are connected by edges representing a relationship between the events, and the control flow graph can thereby express such a flow of processing that traverses a plurality of hosts.

The second embodiment can have the same configuration as that of the first embodiment. Alternatively, in the second embodiment, the receiver 301 may be divided into a node receiver that receives a graph node which is information relating to a node from the monitor 2 and an edge receiver that receives a graph edge from the monitor 2. Similarly, the graph information adder 302 may be divided into a node adder that adds a graph node and an edge adder that adds a graph edge. Hereinafter, the configuration of the second embodiment will be described as being the same as the configuration of the first embodiment.

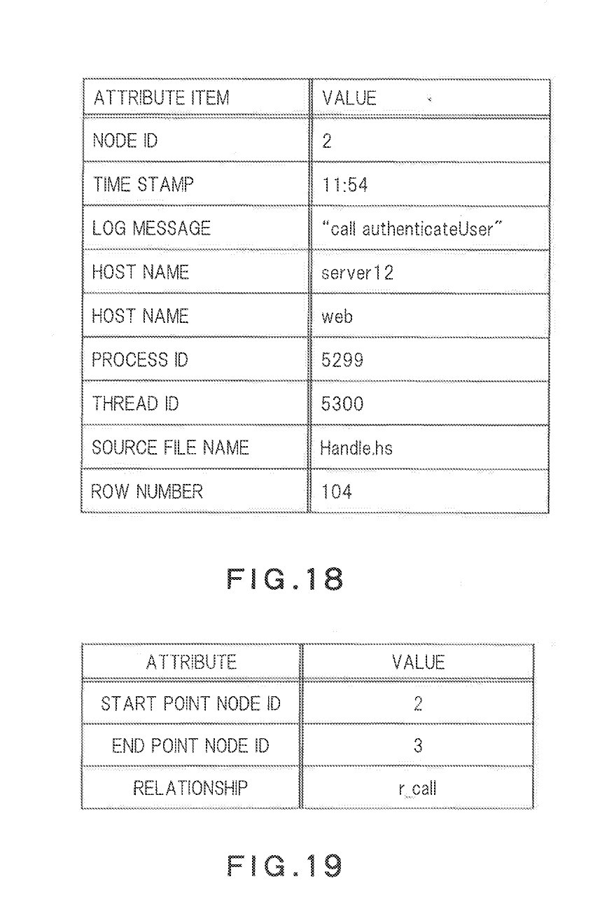

The monitor 2 monitors an event relating to a control flow that occurs in the monitoring target 1 and inputs a detected graph node to the flow graph DB apparatus 3. FIG. 18 is a diagram illustrating an example of the graph node. In the example of FIG. 18, the graph node is made up of attributes such as a node ID and a time stamp indicating a time at which an event meant by the node occurs. These attributes become attribute information stored in each node in a control flow graph. The node ID is an identifier for uniquely identifying a node, but may be reassigned by the node storage 303 when stored in the node storage 303. Furthermore, the node ID may be assigned not by the node storage 303 but by the receiver 301 or graph information adder 302. In this case, the receiver 301 transmits the assigned node ID to the monitor 2.

In addition to graph nodes, the monitor 2 may input graph edges to the flow graph DB apparatus 3. FIG. 19 is a diagram illustrating an example of the data structure of a graph edge in the second embodiment. The graph edge includes three attributes: a start point node ID, an end point node ID and a relationship. The relationship is a relationship between events indicated by the start point node and the end point node. The monitor 2 may input a graph edge simultaneously with a graph node or input a graph edge at timing independent of a graph node.

Regarding the units inside the flow graph DB apparatus 3 of the second embodiment, a graph information adder 302, an edge storage 304 and a data period updater 308 will be described, in which processing different from the processing in the first embodiment is performed.

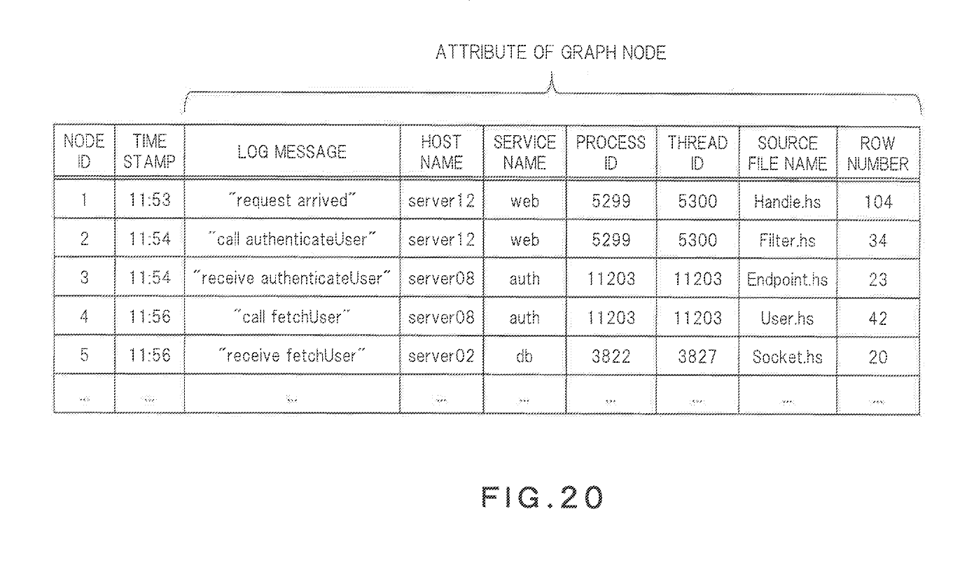

The graph information adder 302 checks whether the acquired information is about a graph node or a graph edge. When a graph node is acquired, the node storage 303 is referenced, and when there is no information on the graph node, the information is added to the node storage 303. Such an addition may be performed by comparing node IDs or by comparing time stamps and the attribute information when node IDs are reassigned at the time of storage. FIG. 20 is a diagram illustrating an example of node data in the second embodiment which is stored in the node storage 303. Unlike the first embodiment, time stamps are included in the node data.

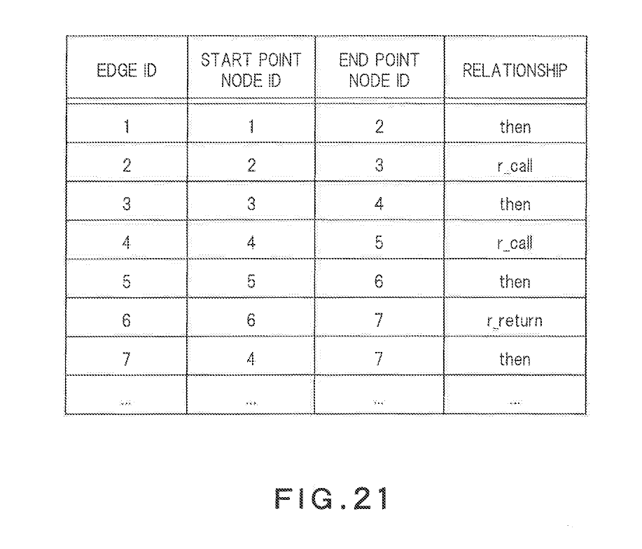

When a graph edge is acquired, the edge storage 304 is referenced and when there is no information about the graph edge, the information is added to the edge storage 304. FIG. 21 is a diagram illustrating an example of edge data in the second embodiment which is stored in the edge storage 304. The edge data includes edge IDs and the attributes of the graph edge shown in FIG. 19. Unlike the first embodiment, no time stamp is included in the edge data. The edge ID may be assigned by the receiver 301, the graph information adder 302 or the edge storage 304.

As in the case of the first embodiment, the data period updater 308 calculates a data period in each segment constructed by the segment constructor 305. However, since no time stamp is included in the edge data in the second embodiment, the data period updater 308 in the second embodiment calculates the data period based on the node data instead of the edge data.

The data period updater 308 uses three types of nodes: segment input nodes, segment output nodes and segment internal nodes instead of three types of edges: the segment input edges, the segment output edges and the segment internal edges used in the first embodiment. The segment input node means a node which is not included in the target segment in the calculation of the data period and has an edge input into a node in the segment. The segment output node means a node which is not included in the target segment in the calculation of the data period and has an edge output from a node in the segment. The segment internal node refers to a node included in the target segment in the calculation of the data period.

The data period updater 308 obtains the segment input nodes, the segment output nodes and the segment internal nodes based on the node data and the edge data. As a more specific example, with reference to the segment storage 306, the data period updater 308 regards all nodes belonging to the target segment in the calculation of the data period as segment internal nodes. With reference to the edge storage 304, the data period updater 308 checks, for each edge, whether or not the start point node and the end point node are segment internal nodes. When the start point node is a segment internal node and the end point node is not included in the target segment, the end point node is assumed to be a segment output node. When the start point node is not included in the target segment and the end point node is a segment internal node, the start point node may be assumed to be a segment input node.

After obtaining the segment input nodes, the segment output nodes and the segment internal nodes, the data period updater 308 may likewise calculate the data period using time stamps of three types of nodes instead of time stamps of the three types of edges in the first embodiment. The rest of the processing is similar to that of the first embodiment.

As described above, according to the second embodiment, it is possible to detect processing carried out at a specific time efficiently and with various types of graph granularity from a control flow graph in which only nodes have time stamps.

### Third Embodiment

The first embodiment uses a data flow graph in which only edge data has time stamps and the second embodiment uses a control flow graph in which only node data has time stamps, whereas a third embodiment is also available which uses a flow graph in which both edge data and node data have time stamps.

The third embodiment has the same configuration as the configurations of the first and second embodiments, but is different in that node data of the node storage 303 and edge data of the edge storage 304 store both attributes of a data flow graph and attributes of a control flow graph.

The data period updater 308 can calculate a data period using six types of time stamps: segment input edges, segment output edges, segment internal edges, segment input nodes, segment output nodes and segment internal nodes. The data period updater 308 may determine types of time stamps used to calculate a data period based on the segment type or the like.

Each process in the embodiments described above can be implemented by software (program). Thus, the search apparatus in the embodiments described above can be implemented using, for example, a general-purpose computer apparatus as basic hardware and causing a processor mounted in the computer apparatus to execute the program.

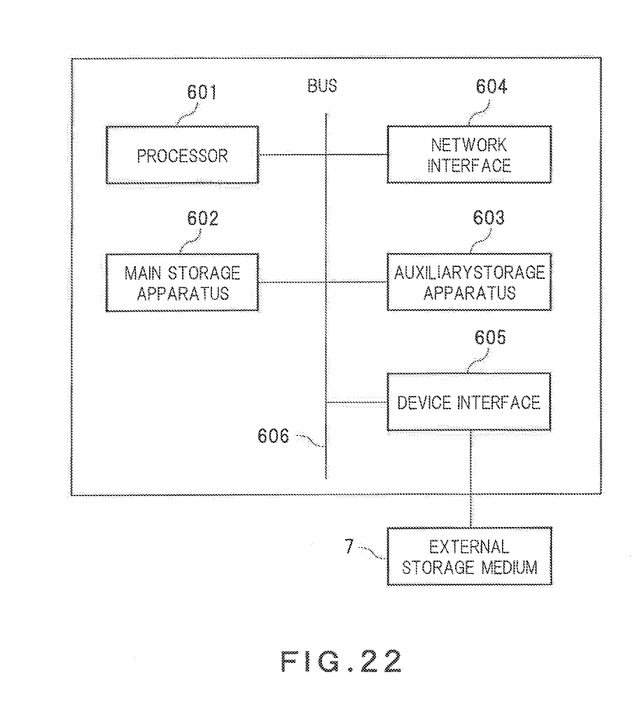

FIG. 22 is a block diagram illustrating an example of a hardware configuration according to an embodiment of the present invention. The search apparatus can be implemented as a computer apparatus provided with a processor 601, a main storage apparatus 602, an auxiliary storage apparatus 603, a network interface 604, a device Interface 605, an input apparatus 606 and an output apparatus 607, with these components being interconnected via a bus 608.

The processor 601 reads a program from the auxiliary storage apparatus 603, develops and executes the program on the main storage apparatus 602, and can thereby implement functions of the receiver 301, the graph information adder 302, the segment constructor 305, the data period updater 308, the search query receiver 310 and the searcher 311.

The search apparatus of the present embodiment may also be implemented by preinstalling a program to be executed by the search apparatus in the computer apparatus or may be implemented by storing a program in a storage medium such as a CD-ROM or distributing the program via a network and installing the program in the computer apparatus as appropriate.

The network interface 604 is an interface for making a connection to a communication network. When a connection is made to the monitor 2 and the graph acquirer 4 or the like via communication, the connection may be made using this network interface 604. Here, although only one network interface is shown, a plurality of network interfaces may be mounted.

The device interface 605 is an interface for making a connection to a device such as an external storage medium 7. The external storage medium 7 may be an optional recording medium such as an HDD, CD-R, CD-RW, DVD-RAM, DVD-R, SAN (storage area network). The edge storage 304, the node storage 303, the segment storage 306, the segment type storage 307 and the data period storage 309 may be connected to the device interface 605 as the external storage medium 7.

Furthermore, the edge storage 304, the node storage 303, the segment storage 306, the segment type storage 307 and the data period storage 309 may be implemented as a database or a table of databases.

The main storage apparatus 602 is a memory apparatus that temporarily stores instructions to be executed by the processor 601 and various types of data, and may be a volatile memory such as DRAM or a non-volatile memory such as MRAM. The auxiliary storage apparatus 603 is a storage apparatus that stores programs and data or the like permanently, and is an HDD or SSD, for example. Data stored in the edge storage 304, the node storage 303, the segment storage 306, the segment type storage 307 and the data period storage 309 is stored in the main storage apparatus 602, the auxiliary storage apparatus 603 or the external storage medium 7.

The terms used in each embodiment should be interpreted broadly. For example, the term “processor” may encompass a general purpose processor, a central processor (CPU), a microprocessor, a digital signal processor (DSP), a controller, a microcontroller, a state machine, and so on. According to circumstances, a “processor” may refer to an application specific integrated circuit (ASIC), a field programmable gate array (FPGA), and a programmable logic device (PLD), etc. The term “processor” may refer to a combination of processing devices such as a plurality of microprocessors, a combination of a DSP and a microprocessor, one or more microprocessors in conjunction with a DSP core.

As another example, the term “storage” or “storage device” employed in the embodiments, may encompass any electronic component which can store electronic information. The “storage” or “storage device” may refer to various types of media such as random access memory (RAM), read-only memory (ROM), programmable read-only memory (PROM), erasable programmable read only memory (EPROM), electrically erasable PROM (EEPROM), non-volatile random access memory (NVRAM), flash memory, magnetic such as an HDD, an optical disc or SSD.

It can be said that the storage electronically communicates with a processor if the processor read and/or write information for the storage. The storage may be integrated to a processor and also in this case, it can be said that the storage electronically communicates with the processor.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

1. A database apparatus comprising:
an information acquirer that acquires, regarding a plurality of processes executed in an information processing system and transitions among the processes, a plurality of pieces of edge information each including first information on an attribute of the process before the transition, second information on an attribute of the process after the transition and third information on an attribute of the transition;
a segment constructor that combines a plurality of data structures each comprising a first node indicated by the first information, a second node indicated by the second information and an edge connecting the first and second nodes indicated by the third information, to obtain a plurality of segments for each of a plurality of segment types, by integrating the same nodes in a plurality of pieces of edge information into one node;
a period calculator that calculates data periods indicating respective time ranges of the plurality of segments based on at least one of the first information, the second information and the third information each related to the first node, the second node and the edge belonging to the plurality of segments; and
a storage that stores the plurality of segments in association with the plurality of the respective data periods calculated by the period calculator.

2. The database apparatus according to claim 1, wherein
the period calculator classifies the first node, the second node or the edge belonging to the segment into a plurality of groups based on a predetermined reference and determines, as the data period, a period between a first time information and a second time information, the first time information being an earliest time information among pieces of time information included in the first information, the second information or the third information related to the first node, the second node or the edge belonging to a first group which is one of the plurality of classified groups and the second time information being a latest time information among pieces of time information included in the first information, the second information and the third information related to the first node, the second node or the edge belonging to a second group which is one of the plurality of classified groups.

3. The database apparatus according to claim 1, wherein
the period calculator classifies a plurality of pieces of time Information included in the first information, the second information and the third Information related to the first node, the second node and the edge belonging to the segment into a plurality of groups based on a distribution of the time information with respect to a time axis and calculates a second data period indicating respective time ranges of the plurality of groups based on at least one of the first information, the second Information and the third information related to the first node, the second node and the edge belonging to the plurality of groups respectively, and
the storage stores the segment in association with the plurality of calculated second data periods.

4. The database apparatus according to claim 3, wherein
the plurality of pieces of time information is classified into the plurality of groups based on a clustering algorithm.

5. The database apparatus according to claim 1, wherein
the first node represents a node from which data processed by the information processing system flows,
the second node represents a node to which the data flows, and
the edge represents an event of a data flow from the first node to the second node.

6. The database apparatus according to claim 1, wherein
the first node and the second node represent execution of a process in the information processing system, and
the edge represents a relationship between the first node and the second node.

7. A search apparatus comprising:
the database apparatus according to claim 1;
a search query receiver that receives a search request; and
a searcher that generates a search processing instruction on the database apparatus based on the search request.

8. The search apparatus according to claim 7, wherein
the search request includes a specification of a period to be searched, and
the database apparatus extracts Information related to the segment stored in association with the data period including a whole of the period of the specified search target.

9. The search apparatus according to claim 7, wherein
the search request includes a specification of a segment type, and
the database apparatus extracts information relating to the segment of the specified segment type.

10. A method of constructing a partial graph comprising:
acquiring, regarding a plurality of processes executed in an information processing system and transitions among the processes, a plurality of pieces of edge information each including first information on an attribute of the process before the transition, second information on an attribute of the process after the transition and third information on an attribute of the transition;
combining a plurality of data structures each comprising a first node indicated by the first information, a second node indicated by the second information and an edge connecting the first and second nodes indicated by the third information, to obtain a plurality of segments for each of a plurality of segment types, by integrating the same nodes in a plurality of pieces of edge information into one node; and
calculating data periods indicating respective time ranges of the plurality of segments based on at least one of the first information, the second information and the third information each related to the first node, the second node and the edge belonging to the plurality of segments.

11. A search method comprising:
constructing a partial graph according to the method of claim 10;
receiving a search request; and
generating a search processing instruction based on the search request.
